(19) United States
(12) Patent Application Publication
(10) Pub. No.: US 2019/0266547 A1
(43) Pub. Date: Aug. 29, 2019

(54) INFORMATION PROCESSING DEVICE, NON-TRANSITORY COMPUTER READABLE STORAGE MEDIUM AND WORK PLAN EDITING SUPPORT METHOD

(71) Applicant: FUJITSU LIMITED, Kawasaki-shi (JP)

(72) Inventors: Koji Yoshioka, Kawasaki (JP); Yukio Ozaki, Yokohama (JP); Satoshi TOMITA, Kawasaki (JP)

(73) Assignee: FUJITSU LIMITED, Kawasaki-shi (JP)

(21) Appl. No.: 16/248,856

(22) Filed: Jan. 16, 2019

(30) Foreign Application Priority Data
Feb. 27, 2018 (JP) 2018-032874

(51) Int. Cl. G06Q 10/06

(52) U.S. Cl. CPC G06Q 10/063116; G06Q 10/063114

(57) ABSTRACT

An information processing device includes a memory; and a processor coupled to the memory and configured to: calculate, when an assignment destination of a single task assigned to a person is changed to one of a plurality of arms of a robot in a state where tasks are assigned to the person and each arm of the robot, a working time of the person and a working time of the robot after the change of the assignment destination; compare the calculated working time of the person with the calculated working time of the robot; and generate a warning when the working time of the robot is longer than the working time of the person as a result of comparison.

### CROSS-REFERENCE TO RELATED APPLICATION

This application is based upon and claims the benefit of priority of the prior Japanese Patent Application No. 2018-032874 filed on Feb. 27, 2018, the entire contents of which are incorporated herein by reference.

### FIELD

A certain aspect of the embodiments described herein relates to an information processing device, a non-transitory computer readable storage medium, and a work plan editing support method.

### BACKGROUND

An information processing device which performs process design for line production assigns tasks to persons (workers) and automated machines such as robots, and then presents individual workloads to a process designer with use of a workload chart (a piling chart).

When all combination are searched in order to obtain an optimal working order at the time of the process design, the search time becomes extremely longer and impractical, and therefore the information processing device searches for an appropriate process plan by a local search method. In this case, since the searched process plan may not be an optimal solution, the information processing device presents the workload chart to the process designer to cause the process designer to check the appropriateness of the assignment result as described above, and accepts modification of the workload chart by the process designer if necessary.

Document 1 (Japanese Laid-open Patent Publication No. 2009-297880) discloses an article management system capable of preventing generation of useless time caused by a storage place of articles during a cooperative operation between a person and a robot. Document 2 (Japanese Laid-open Patent Publication No. 2010-211726) discloses a simulation method of production work simulation performed by cooperation between an operator and a robot.

### SUMMARY

According to an aspect of the embodiments, there is provided an information processing device comprising: a memory; and a processor coupled to the memory and configured to: calculate, when an assignment destination of a single task assigned to a person is changed to one of a plurality of arms of a robot in a state where tasks are assigned to the person and each arm of the robot, a working time of the person and a working time of the robot after the change of the assignment destination; compare the calculated working time of the person with the calculated working time of the robot; and generate a warning when the working time of the robot is longer than the working time of the person as a result of comparison.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram schematically illustrating a hardware configuration of an information processing device in accordance with an embodiment;

FIG. 2 is a functional block diagram of the information processing device in FIG. 1;

FIG. 3 is a diagram illustrating a task DB;

FIG. 4 is a diagram illustrating a robot, tool supply units and parts supply units;

FIG. 5 is a diagram illustrating an example of a display screen of a process plan;

FIG. 6 is a flowchart illustrating an example of a process executed by a process plan change unit and a warning unit;

FIG. 7 is a diagram (No. 1) useful in explaining the process of FIG. 6;

FIGS. 8A and 8B are diagrams (No. 2) useful in explaining the process of FIG. 6;

FIGS. 9A and 9B are diagrams (No. 3) useful in explaining the process of FIG. 6;

FIGS. 10A and 10B are diagrams (No. 4) useful in explaining the process of FIG. 6;

FIGS. 11A and 11B are diagrams (No. 1) useful in explaining other example of the process plan;

FIGS. 12A and 12B are diagrams (No. 2) useful in explaining other example of the process plan; and

FIGS. 13A and 13B are diagrams useful in explaining variation of the other example of the process plan.

### DESCRIPTION OF EMBODIMENTS

The process designer needs to be careful to meet a constraint condition on the work order of each work and a constraint condition on working time when modifying the process plan. However, the process designer may not notice that the constraint conditions are not met in the middle of modifying the process plan. When the modification of the process plan is advanced even though it does not meet the constraint conditions, it is likely not to be able to obtain an appropriate process plan.

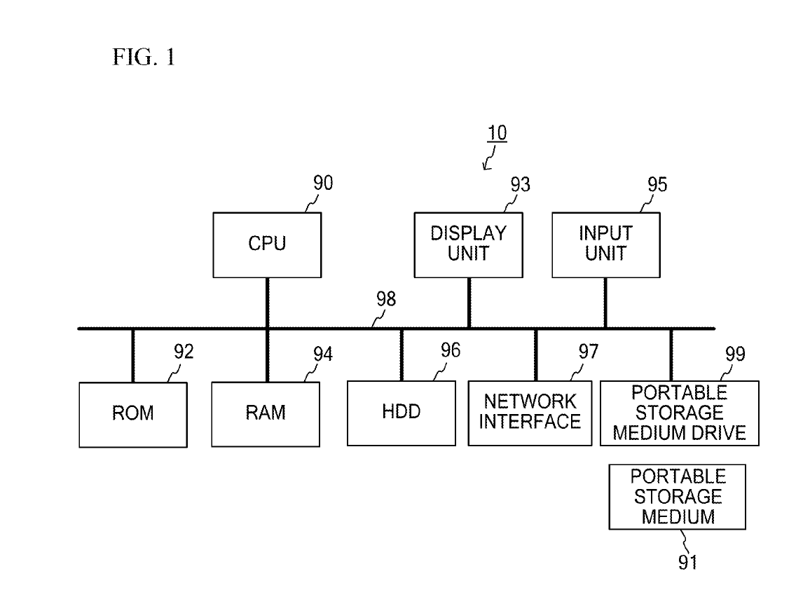

Hereinafter, an embodiment of an information processing device that assists designing a process plan (also called work plan) by a process designer will be described in detail with reference to FIGS. 1 to 13.

An information processing device 10 of the present embodiment generates a process plan (an assignment plan of tasks to a person and a robot) in an assembly line including a person and a robot and displays the generated process plan. When a change request for the displayed process plan is submitted from the process designer, the information processing device 10 changes the process plan based on the change request and displays the process plan after the change.

In the present embodiment, in the assembly line, a product is conveyed from one station to another station by a conveyor (not illustrated). A person or a robot is assigned to each station of the assembly line. The person or the robot assigned to each station executes tasks assigned according to the process plan to the product conveyed in the assembly line to produce products. The number of persons and the number of robots are freely selected. Thus, the number of robots may be one or two or more.

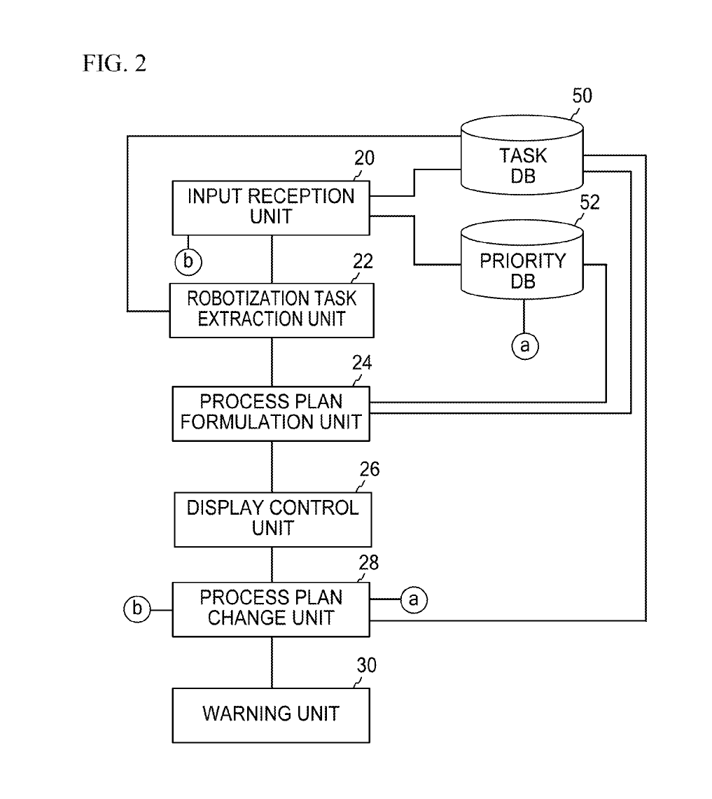

FIG. 1 is a diagram schematically illustrating a hardware configuration of the information processing device 10 in accordance with an embodiment. The information processing device 10 is, for example, a personal computer (PC), and includes a central processing unit (CPU) 90, a read only memory (ROM) 92, a random access memory (RAM) 94, a storage unit (here, a hard disk drive (HDD)) 96, a network interface 97, a portable storage medium drive 99, a display unit 93, and an input unit 95 as illustrated in FIG. 1. Examples of the display unit 93 include, but are not limited to, a liquid crystal display or the like, and examples of the input unit 95 include, but are not limited to, a keyboard, a mouse, and a touch panel. Each component of the information processing device 10 is connected to a bus 98. A function of each unit illustrated in FIG. 2 is implemented in the information processing device 10 by the CPU 90 executing programs (including a work plan editing support program) stored in the ROM 92 or the HDD 96 or programs (including the work plan editing support program) read from a portable storage medium 91 by the portable storage medium drive 99. FIG. 2 also illustrates a task database (DB) 50 and a priority DB 52 stored in the HDD 96 or the like of the information processing device 10. Examples of the portable storage medium 91 include, but are not limited to, a CD-ROM, a DVD disc, a portable storage medium such as a Universal Serial Bus (USB) memory, and a semiconductor memory such as a flash memory. Here, a function of each unit illustrated in FIG. 2 may be implemented by integrated circuits such as an Application Specific Integrated Circuit (ASIC) and a Field Programmable Gate Array (FPGA), for example.

FIG. 2 illustrates a functional block diagram of the information processing device 10. As illustrated in FIG. 2, the execution of a program by the CPU 90 causes the information processing device 10 to function as an input reception unit 20, a robotization task extraction unit 22, a process plan formulation unit 24, a display control unit 26, a process plan change unit 28 and a warning unit 30.

The input reception unit 20 receives information on tasks required to be executed in a production line and information on a priority of each task, which are input by a process designer through the input unit 95, and stores the information in the task DB 50 and the priority DB 52. In addition, when the process designer inputs information to modify the process plan displayed on the display unit 93, the input reception unit 20 receives input of the modification information, and transmits the modification information to the process plan change unit 28.

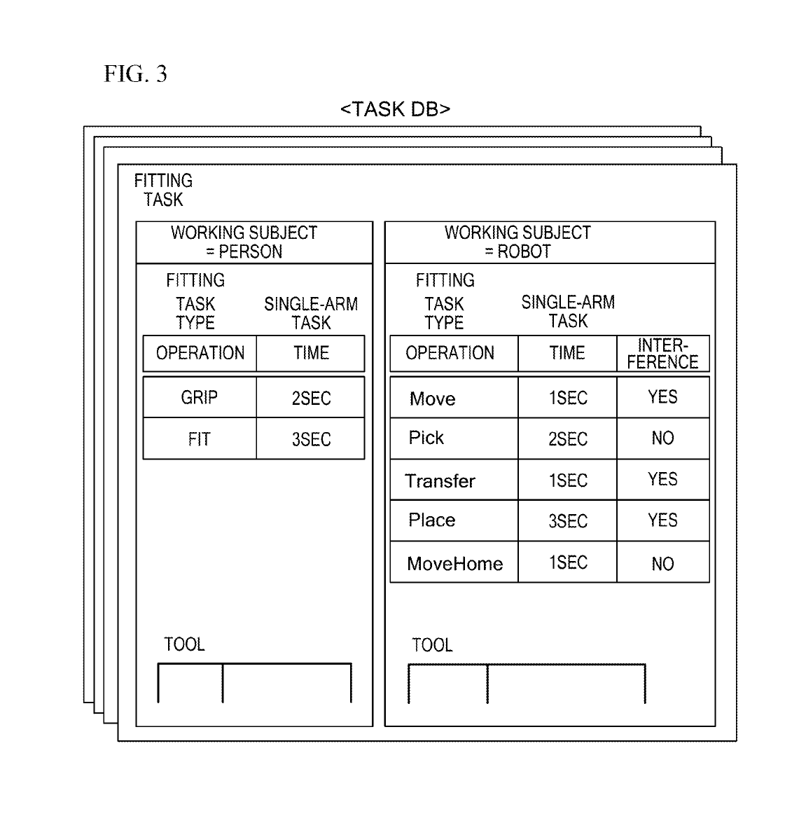

In FIG. 3, the task DB 50 is illustrated. The task DB 50 is a database storing information on each task as illustrated in FIG. 3. The task includes one or more operations, and the information on each task includes information on operations, a task type, and information on necessary tools when a person executes the task (a working subject is a person), and information on operations, a task type, and information on necessary tools when a robot executes the task (a working subject is a robot). For example, in the case of a “fitting task” illustrated in FIG. 3, when the working subject is the person, the task type is a single-arm task, and the operations are “GRIP” and “FIT”. Additionally, the time required for the task (the sum of operation times) is 5 seconds. On the other hand, when the working subject is the robot, the task type is the single-arm task, the operations are “Move”, “Pick”, “Transfer”, “Place”, and “MoveHome”. The time required for the task is 8 seconds. Additionally, among these operations of the robot, “Move”, “Transfer”, and “Place” are operations in an “interference region” described later (referred to as an interference operation), and “Pick” and “MoveHome” are operations in a “non-interference region” described later (referred to as a non-interference operation). In general, when the task can be assigned to either the person or robot, the working time of the robot is longer than that of the person.

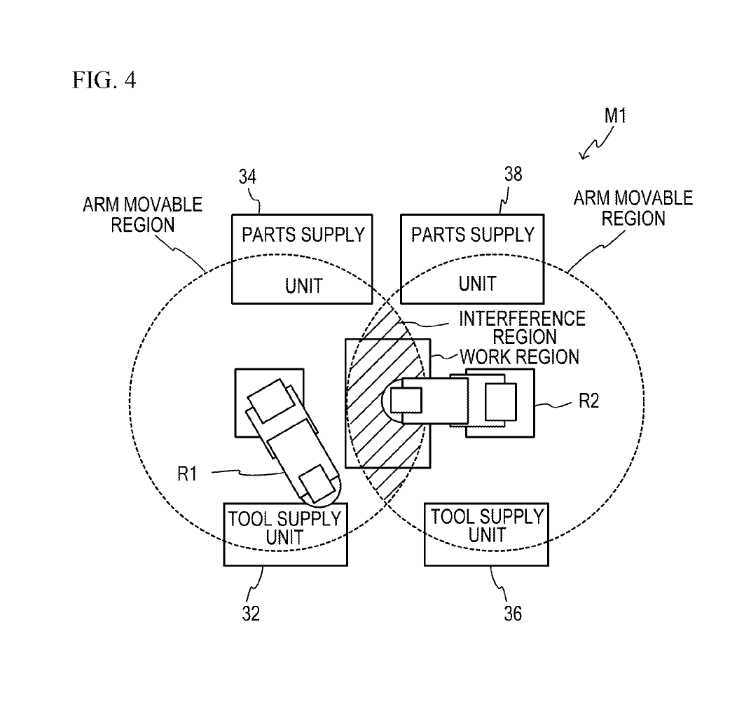

Here, the present embodiment uses a robot M1 having two arms R1 and R2 as the robot, as illustrated in FIG. 4. A tool supply unit 32 and a parts supply unit 34 are located in the movable region of the arm R1, while a tool supply unit 36 and a parts supply unit 38 are located in the movable region of the arm R2. In the tool supply units 32 and 36, the arms R1 and R2 change tools to be used (i.e., execute tool change). In the parts supply units 34 and 38, the arms R1 and R2 execute an operation to pick up a part (i.e., execute the operation “Pick”). In a work region illustrated in FIG. 4, the arms R1 and R2 individually or cooperatively execute tasks. In the present embodiment, since there is a case where the arms R1 and R2 cooperatively execute a task, the movable regions of the arms R1 and R2 partly overlap with each other. The overlapping region is the “interference region” in which the arms R1 and R2 may interfere with each other, and the region other than the interference region of the movable region of each arm is the “non-interference region”. In the present embodiment, while one of the arms executes a single-arm task (i.e., a task other than a cooperative task) in the interference region, the other of the arms executes the non-interference operation or waits in the non-interference region in order to avoid collision between the arms.

Referring back to FIG. 2, the priority DB 52 stores information on a priority of each task. The priority is determined by an assembling order on the basis of a parts structure and an assembly structure. For example, the higher the need for the task to be executed first, the higher the priority is set. Then, in the priority DB 52, the priority is defined for each task.

The robotization task extraction unit 22 extracts a task to be assigned to a robot from tasks to be executed in the assembly line. More specifically, the robotization task extraction unit 22 extracts the task to be assigned to the robot based on a positional relationship between the person and the robot in the assembly line, the information in the task DB 50 (for example, the information indicating whether each task is able to be assigned to the robot), and the like.

The process plan formulation unit 24 assigns tasks to the person and the robot assigned to each station of the assembly line by using the extraction results by the robotization task extraction unit 22 to formulate a process plan. The process plan formulation unit 24 assigns tasks to the person and the robot assigned to each station according to a local search method such as taboo search and an annealing method, in consideration of a plurality of parameters including parameters about workability of the person and the robot. The parameters include temporal variability among stations, a parameter indicating whether the same tool is integrated in a particular station, and a parameter indicating whether the priority defined in the priority DB 52 is followed.

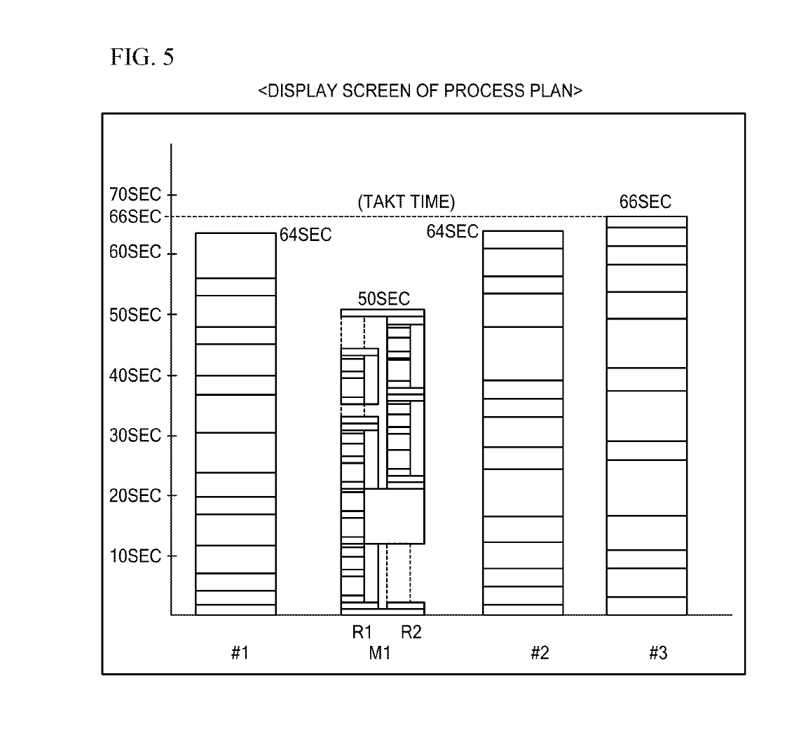

The display control unit 26 generates a screen that displays a workload chart (a piling chart) of the process plan formulated by the process plan formulation unit 24, and displays the generated display screen on the display unit 93. For example, the display control unit 26 displays the display screen of the process plan as illustrated in FIG. 5 on the display unit 93. In the example of FIG. 5, the workload chart of the process plan in a case where three persons (#1, #2 and #3) are assigned to each station of the assembly line and the robot (M1) is assigned between the persons #1 and #2 is illustrated. In each station, the person or robot sequentially executes tasks piled up in the workload chart from the bottom.

When the process plan change unit 28 receives, from the input reception unit 20, the change request of the process plan (i.e., the change request of the assignment destination of each task) input by the process designer who saw the display screen of the process plan formulated by the process plan formulation unit 24, the process plan change unit 28 performs a process to change the process plan. Here, the process to be executed by the process plan change unit 28 is described later in detail.

When the process plan change unit 28 changes the process plan in accordance with the change request from the process designer, the warning unit 30 determines whether the changed process plan meets a prescribed condition, and generates a warning when the changed process plan does not meet the prescribed condition.

(Regarding Process of Process Plan Change Unit 28 and Warning Unit 30)

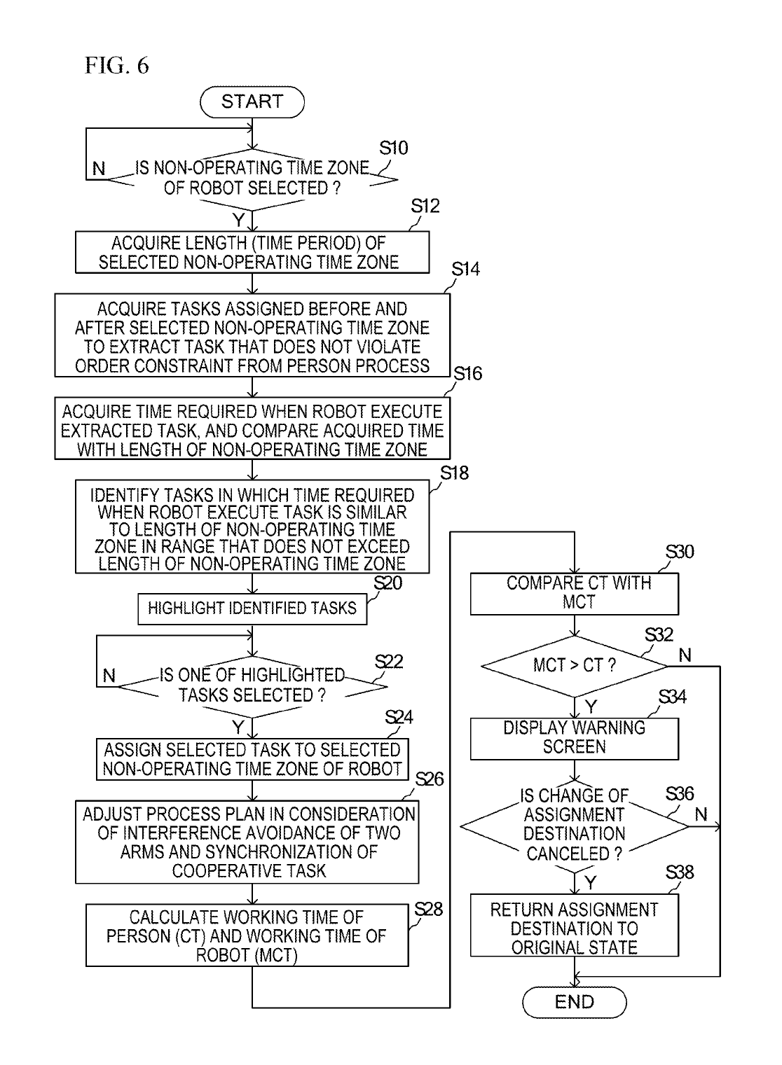

Hereinafter, a detailed description will be given of the process to be executed by the process plan change unit 28 and the warning unit 30 along a flowchart of FIG. 6 with reference to other drawings as appropriately. Here, it is assumed that, as a premise of the process of FIG. 6, the process plan formulation unit 24 has already formulated the process plan, and the display control unit 26 has displayed the display screen indicating the workload chart of the process plan formulated by the process plan formulation unit 24 on the display unit 93.

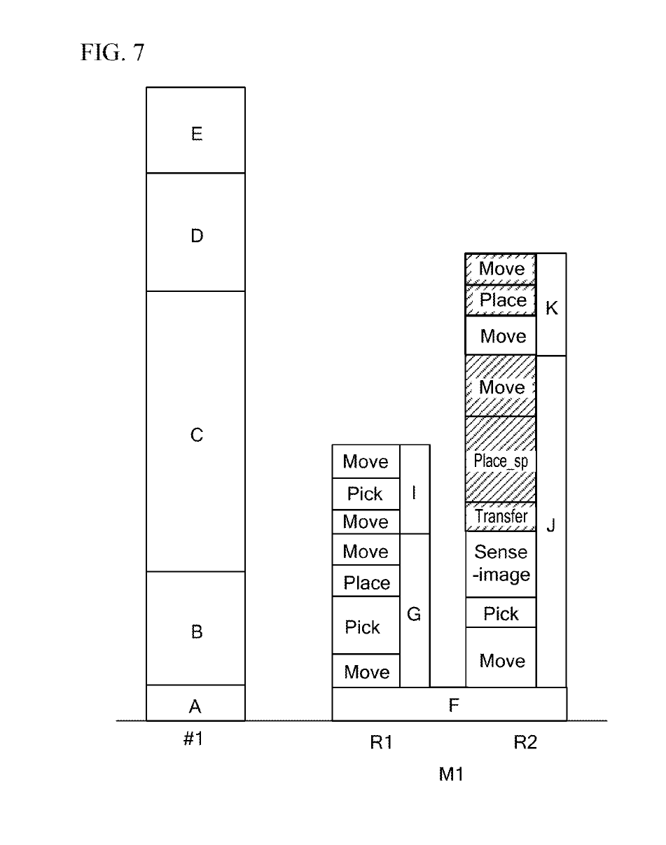

In FIG. 7, a part of the workload chart of the process plan (i.e., a part corresponding to the person #1 and the robot M1) displayed on the display unit 93 is illustrated. In the example of FIG. 7, each of alphabets A to K indicates a task, and each of character strings “Move”, “Pick” and the like indicates an operation included in each task. The operation indicated by a single-hatched frame represents the operation in the interference region (i.e., the interference operation), and the operation indicated by a frame without hatching represents the operation in the non-interference region (i.e., the non-interference operation). The dimension in the vertical direction of each frame in FIG. 7 represents the time required for each task or operation. The width in the vertical direction of the frame of each task piled up in the workload chart represents a workload (i.e., a time required for the task).

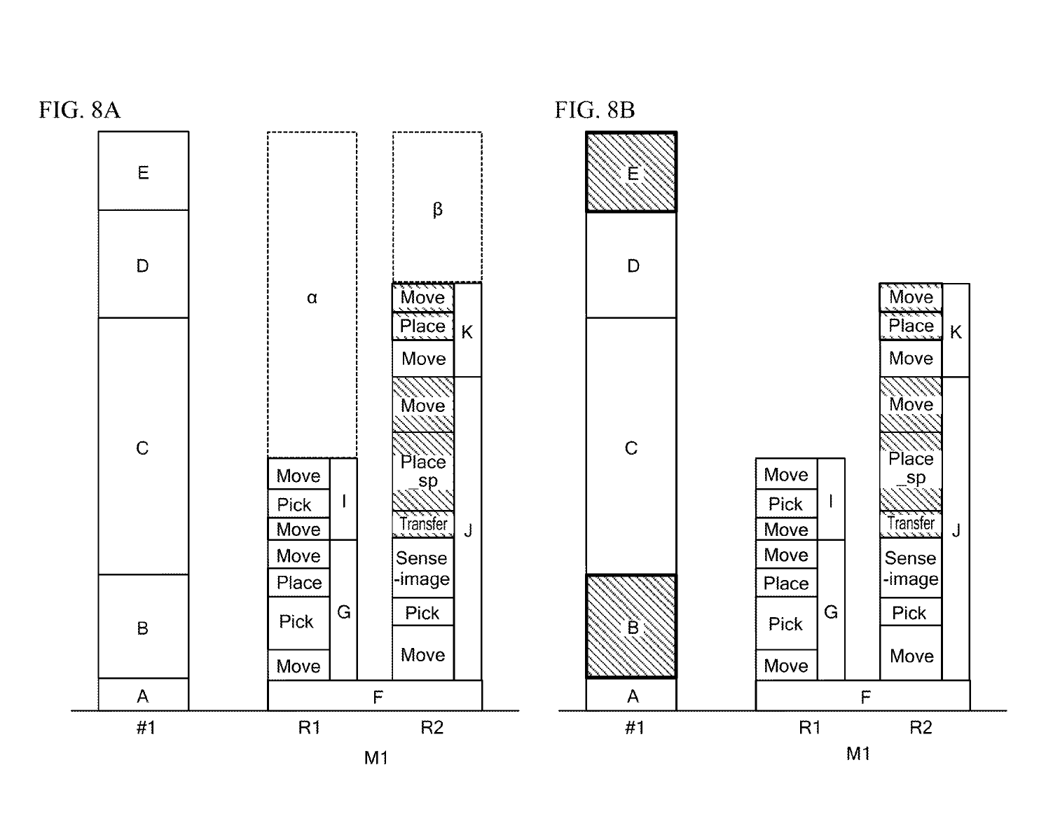

In the process of FIG. 6, at step S10, the process plan change unit 28 waits until a non-operating time zone of the robot is selected. For example, the non-operating time zone of the robot is a time zone α or time zone β indicated by a dashed line frame in FIG. 8A. When the process designer selects the non-operating time zone α or β through the input unit 95, the process plan change unit 28 moves the process to step S12. Here, it is assumed that the process designer selects the non-operating time zone α as an example.

At step S12, the process plan change unit 28 acquires a length (i.e., a time period) of the selected non-operating time zone. When the process designer selects the non-operating time zone α, the process plan change unit 28 acquires the length of the non-operating time zone α.

Next, at step S14, the process plan change unit 28 acquires tasks assigned before and after the selected non-operating time zone to extract a task that does not violate an order constraint from a person process. That is, the process plan change unit 28 acquires tasks to be executed immediately before and after the selected non-operating time zone α from the workload chart, and extracts the task that does not violate the order constraint even if being performed between the two acquired tasks, from the tasks assigned to the person, with reference to the priority DB 52. Here, it is assumed that the tasks B, C, D and E assigned to the person (#1) illustrated in FIG. 8A are extracted as an example.

Next, at step S16, the process plan change unit 28 acquires the time required when the robot executes the extracted tasks, and compares the acquired time with the length of the non-operating time zone. In this case, the process plan change unit 28 acquires the sum of working times of “working subject=robot” regarding the extracted tasks B, C, D and E, with reference to the task DB 50 of FIG. 3. Then, the process plan change unit 28 compares the acquired working time required for each task with the time period of the non-operating time zone α.

Next, at step S18, the process plan change unit 28 identifies one or more tasks in which the time required when the robot executes the task is similar to the length of the non-operating time zone in a range that does not exceed the length of the non-operating time zone. Here, it is assumed as an example that the time required when the robot executes the tasks B and E is similar to the time period of the non-operating time zone α in the range that does not exceed the time period of the non-operating time zone α (e.g. a time difference is within a prescribed range).

Next, at step S20, the process plan change unit 28 highlights the identified tasks. For example, the process plan change unit 28 presents, to the process designer, that the tasks B and E are movable to the non-operating time zone α by displaying the tasks B and E with thick line frames or displaying the tasks B and E with a changed color, as illustrated in FIG. 8B.

Next, at step S22, the process plan change unit 28 waits until one of the highlighted tasks is selected. When the process designer selects the task E through the input unit 95, for example, the process plan change unit 28 moves the process to step S24.

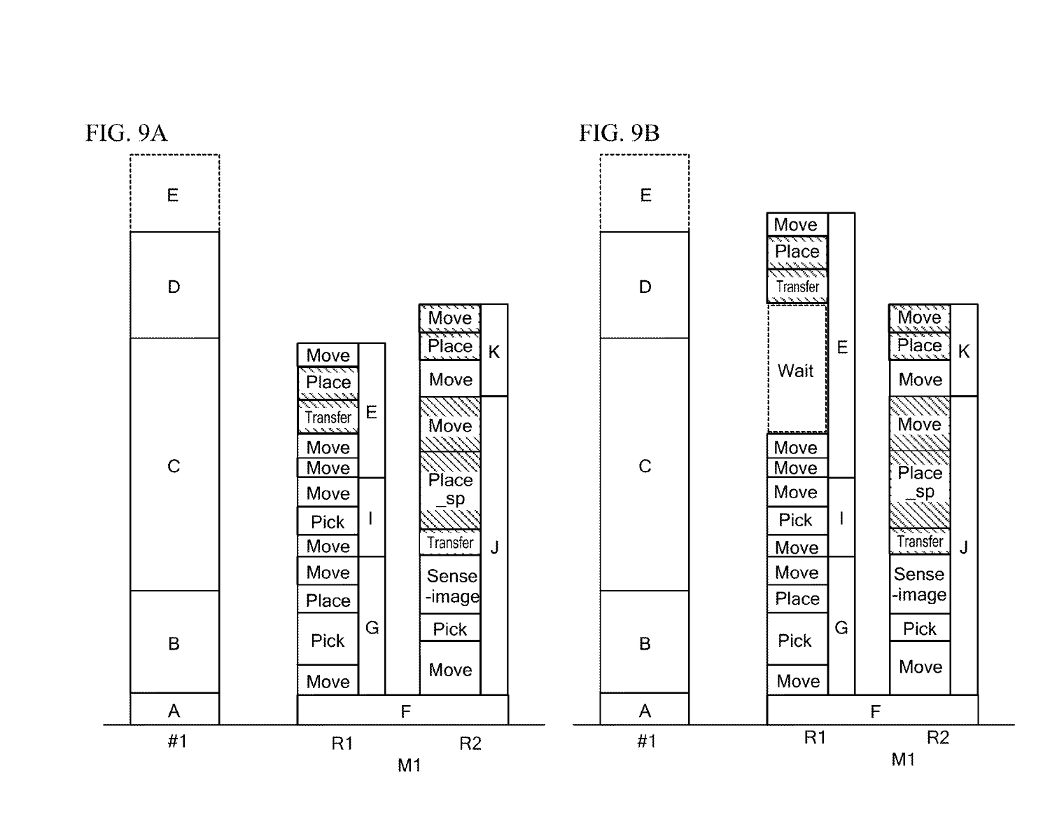

At step S24, the process plan change unit 28 assigns the selected task to the selected non-operating time zone of the robot. Here, the task E is assigned to the non-operating time zone α, as illustrated in FIG. 9A.

Next, at step S26, the process plan change unit 28 adjusts the process plan in consideration of interference avoidance of two arms and the synchronization of a cooperative task. In an example of FIG. 9A, the process plan change unit 28 adjusts the process plan so that both arms R1 and R2 of the robot M1 do not perform an interference operation at the same time. By this adjustment, the workload chart of the process plan is changed as illustrated in FIG. 9B. In an example of FIG. 9B, the arm R1 has a waiting time (“Wait”) so that the interference operation of the arm R1 does not interfere with the interference operation of the arm R2. Here, when the waiting time is generated due to factors other than the interference avoidance and the synchronization of the cooperative task, the process plan change unit 28 further considers the waiting time.

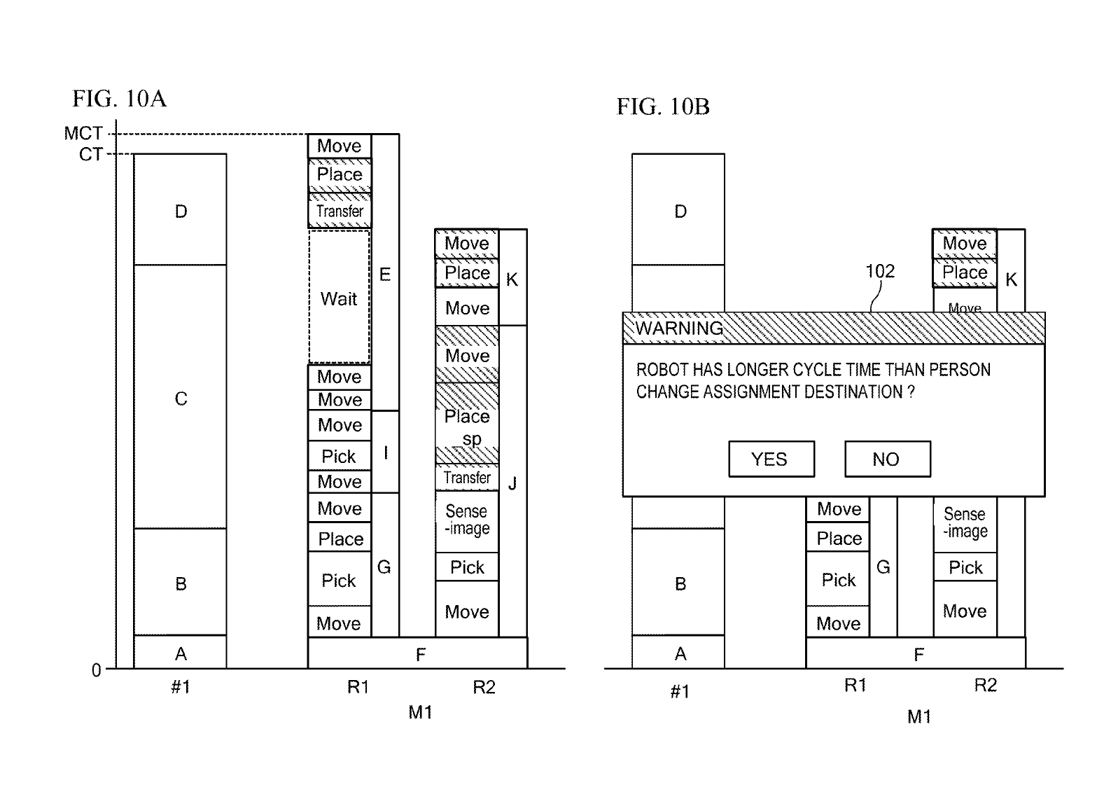

Next, at step S28, the process plan change unit 28 calculates the working time of the person (hereinafter referred to as “CT: Cycle Time”) and the working time of the robot (hereinafter referred to as “MCT: Machine Cycle Time”). Here, the CT and the MCT are times illustrated in FIG. 10A.

Next, at step S30, the process plan change unit 28 compares the CT with the MCT. Then, at step S32, the warning unit 30 determines whether the MCT is longer than the CT.

Since the MCT is longer than the CT in an example of FIG. 10A, the determination at step S32 becomes Yes and the process moves to step S34. When the MCT is shorter than the CT, the determination at step S32 becomes No and all process of FIG. 6 completes.

At step S34, the warning unit 30 displays a warning screen. For example, a warning screen 102 is superposed and displayed on the display screen of the process plan, as illustrated in FIG. 10B. The warning screen 102 of FIG. 10B includes a statement notifying the process designer that the cycle time of the robot is long, and a button to ask the process designer whether the work for changing the assignment destination of the task is continued as it is or stopped. The process designer presses a Yes button when he wants to continue the work for changing the assignment destination of the task, and presses a No button when he wants to cancel the same work. In the present embodiment, when the MCT is longer than the CT, the person is in a standby state and a wasted time occurs. In this case, even if the work for changing the assignment destination of the task is continued as it is, there is a high possibility that an appropriate work process cannot be obtained, and it is therefore decided to immediately warn the process designer to that effect. On the other hand, the “Yes” and “no” buttons are provided in order to allow the process designer to continue the work for changing the assignment destination of the task after the process designer recognizes the warning, which ensures a degree of freedom of the process designer.

Next, at step S36, the process plan change unit 28 determines whether to cancel changing the assignment destination. For example, when the process designer presses the “Yes” button, the determination at step S36 becomes No and all process of FIG. 6 completes. On the other hand, when the process designer presses the “No” button, the determination at step S36 becomes Yes and the process moves to step S38.

At step S38, the process plan change unit 28 returns the assignment destination to an original state. When the “No” button is pressed in the screen of FIG. 10B, the process plan change unit 28 returns the screen to a state of FIG. 7, and all process of FIG. 6 completes.

Even after all process of FIG. 6 is completed, until an instruction indicative of completing the change work is input from the process designer, the process of FIG. 6 is performed repeatedly. Thereby, after the assignment of the task is changed from the person to the robot, for example, it is also possible to change the assignment of the task from the same person or another person to the robot.

When the process plan change unit 28 identifies the tasks assigned to the person process at step S18, the process plan change unit 28 do not have to identify tasks which take a longer working time than a difference between the working time of the person (#1) and the working time of the robot (M1) (i.e., tasks which take a long working time when the working subject is the person). That is, the tasks in which the MCT is longer than the CT at the stage of step S24 do not have to be identified from the beginning (i.e., the process designer may be prevented from selecting such tasks from the beginning).

(Regarding Another Example)

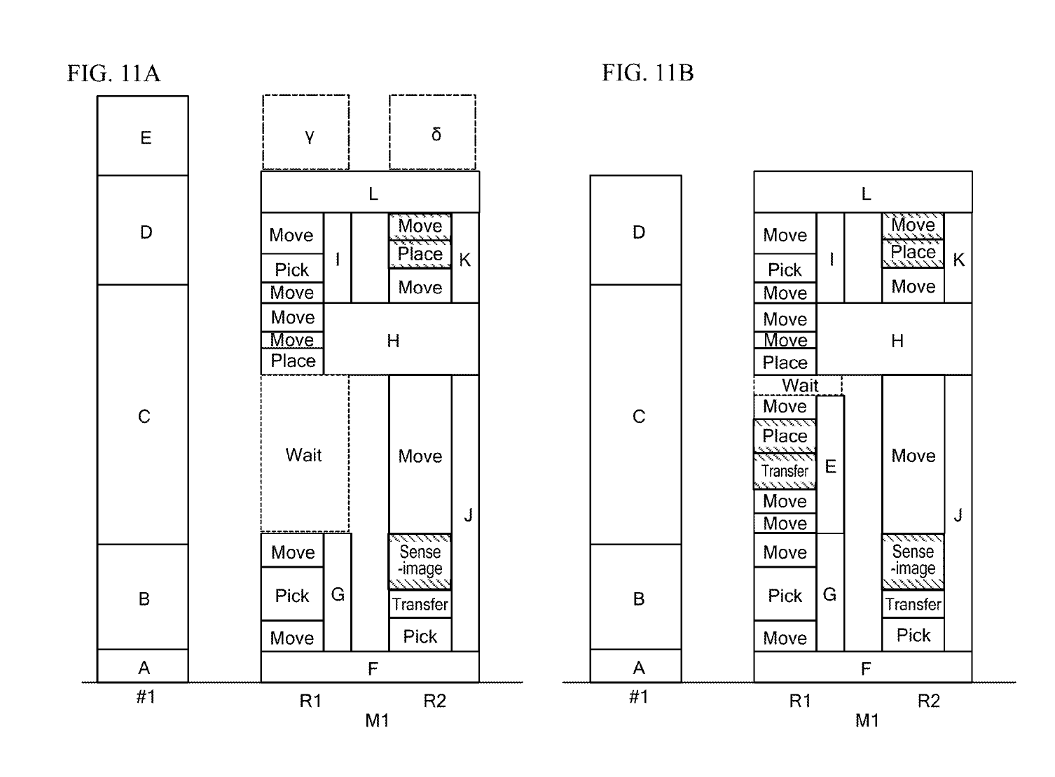

Next, a description will be given of another example of the process plan. FIG. 11A illustrates a part of a process plan chart (the person #1 and the robot M1) according to another example. In FIG. 11A, a task H of the robot M1 is a task cooperatively executed by the two arms R1 and R2 (i.e., the cooperative task). The cooperative task H, for example, includes a complex assembly task including cable forming or the like. In order to execute the cooperative task H, the arm R1 waits until a task J of the arm R2 is finished after a task G. In the example of FIG. 11A, the waiting time indicated by a dashed line frame (“Wait”) and time zones γ and δ indicated by a two-dot chain line frame are the non-operating time zones.

It is assumed in this example that the process designer selects the waiting time (“Wait”) as the non-operating time zone (step S10 in FIG. 6). Moreover, it is assumed that the process designer selects a task E from the highlighted tasks as a result of the process of steps S12 to S20 in FIG. 6 (step S22).

In this case, although the task E is assigned to the waiting time of the robot as illustrated in FIG. 11B, the waiting time occurs to the arm R1 since the arms R1 and R2 cooperatively execute the task H (steps S24 and S26 in FIG. 6).

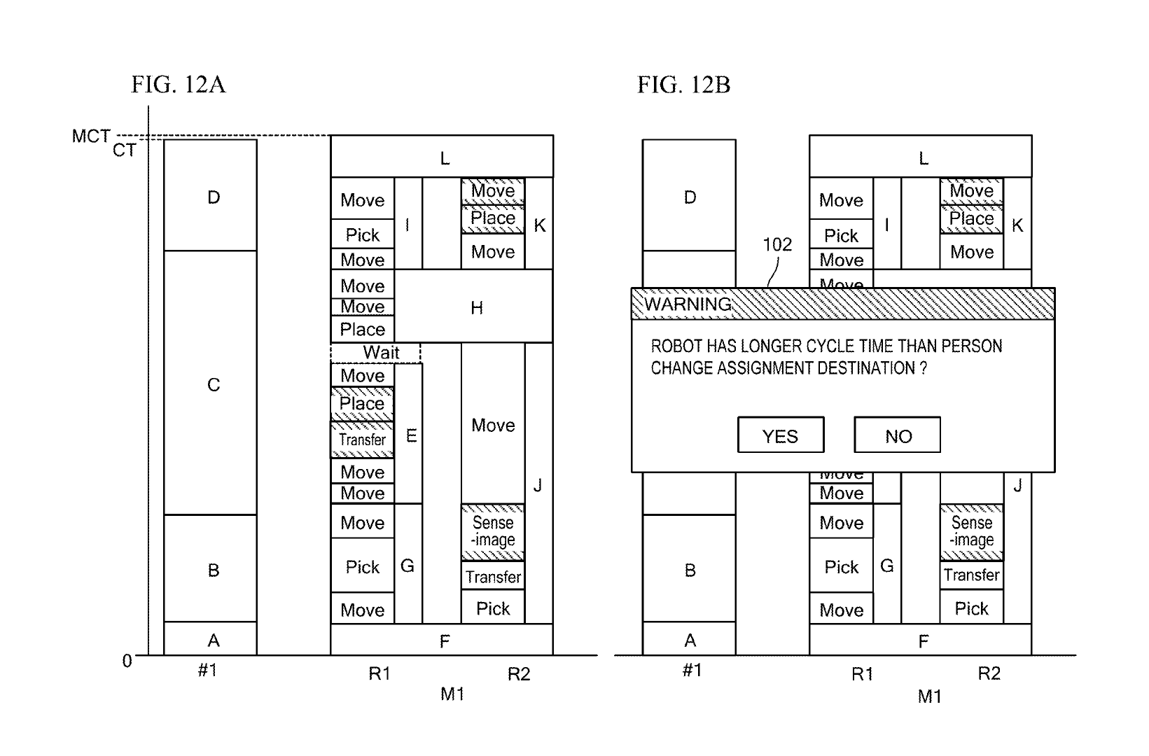

After the assignment of the task E is changed to the arm R1 of the robot M1 as described above, the process plan change unit 28 calculates the working time (“CT”) of the person and the working time (“MCT”) of the robot to compare the CT with the MCT (steps S28 and S30). Then, when the MCT is longer than the CT as illustrated in FIG. 12A (Yes in step S32), the warning screen 102 is displayed as illustrated in FIG. 12B (step S34).

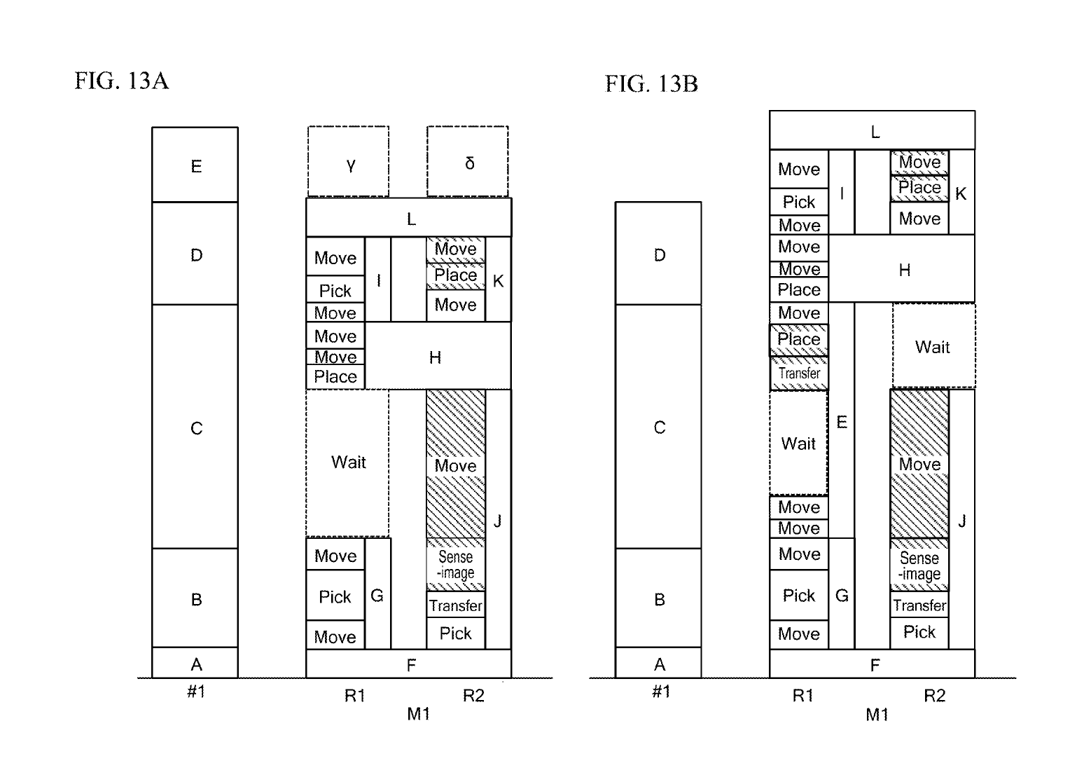

Here, it is assumed in another example that the operation “Move” of the task J of the arm R2 is the interference operation as illustrated in FIG. 13A. In this case, when the task E is assigned to the waiting time (“Wait”) as illustrated in FIG. 13B, the arm R1 has to wait in order to avoid the interference with the arm R2 during the task E, and the arm R2 has to wait in order to execute the cooperative task H until the task E of the arm R1 is finished after the task J (steps S24 and S26 in FIG. 6). Thus, when the working time (MCT) of the robot is longer than the working time (CT) of the person (Yes in step S32) due to the occurrence of the waiting time, the warning screen 102 is displayed as with FIG. 12B (step S34).

As is evident from the above-mentioned description, in the present embodiment, the process plan change unit 28 serves as a calculation unit that calculates the working time of the person and the working time of the robot after the assignment destination of the task is changed, and a comparison unit that compares the working time of the person calculated by the calculation unit with the working time of the robot calculated by the calculation unit. Moreover, the process plan change unit 28 serves as a presentation unit that, when the process designer selects a single non-operating time zone from the non-operating time zones of each arm of the robot, identifies and presents a task assigned to the person, in which the assignment destination is changeable to the selected non-operating time zone.

As described above in detail, in the present embodiment, when the assignment destination of a single task assigned to the person is changed to any one of the arms of the robot in a state where tasks are assigned to the person and each arm of the robot M1 having the two arms R1 and R2 (e.g. a state of FIG. 7), the process plan change unit 28 calculates the working time (CT) of the person and the working time (MCT) of the robot after the change of the assignment destination (step S28), and compares the calculated working time (CT) of the person with the calculated working time (MCT) of the robot (step S30). Then, when the working time (MCT) of the robot is longer than the working time (CT) of the person as a result of the comparison, the warning unit 30 displays the warning screen (step S34). Thereby, it is possible to notify the process designer of a warning when the MCT exceeds the CT, i.e., when the person is in the standby state and the wasted time occurs. Therefore, it is possible to prevent the process plan from being created such that the MCT exceeds the CT. The process designer understands that the standby state of the person occurs in the process plan after the change of the assignment destination, and then can determine whether to continue the work for changing the assignment destination. Moreover, since the process designer understands the content of the warning even if he continues the work for changing the assignment destination, he can proceed the work for changing the assignment destination in consideration that the MCT exceeds the CT.

In the present embodiment, the warning unit 30 displays a warning that is selectable whether to allow the change of the assignment destination on the warning screen (i.e. the waning is displayed along with “Yes” and “No” buttons). Thereby, the process designer can determine whether to continue the change of the assignment destination based on self-determination, and therefore the degree of freedom of the process design can be given to the process designer.

In the present embodiment, the process plan change unit 28 calculates the working time (MCT) of the robot in consideration of whether the operation included in each task assigned to each of the arms R1 and R2 of the robot M1 is the operation in the interference region or non-interference region. Thereby, since the working time (MCT) of the robot can be calculated in consideration of the waiting time that occurs to prevent multiple arms from performing the interference operation at the same time, it is possible to properly perform the warning even when the working time of the robot increases by the occurrence of the wait time and the MCT exceeds the CT.

In the present embodiment, the process plan change unit 28 calculates the working time (MCT) of the robot based on whether the operation included in each task assigned to each of the arms R1 and R2 of the robot M1 is an operation which the plurality of arms cooperatively execute. Thereby, since the working time (MCT) of the robot can be calculated in consideration of the waiting time required for the cooperative operation of the plurality of arms, it is possible to properly perform the warning even when the working time of the robot increases by the occurrence of the wait time and the MCT exceeds the CT.

In the present embodiment, when the process plan change unit 28 receives the selection of a single non-operating time zone from the non-operating time zones of each of the arms R1 and R2 of the robot M1, the process plan change unit 28 identifies and highlights a task assigned to the person, in which the assignment destination is changeable to the selected non-operating time zone (steps S18 and S20). Then, when the process plan change unit 28 receives the selection of the highlighted task, the process plan change unit 28 calculates the working time (MCT) of the robot after the selected task is assigned to the selected non-operating time zone, and calculates the working time (CT) of the person excluding a working time for the selected task. Thereby, since the process designer is allowed to receive presentation of a task which is likely to be assigned to the non-working time zone of the arm from among tasks assigned to the person, the assignment destination of the presented task can be easily changed by selecting the presented task.

The above embodiment has described a case where the display of the warning screen 102 on the display unit 93 gives the warning to the process designer, but this does not intend to suggest any limitation, and the warning may be given by voice, warning sound or the like.

The above embodiment has described a case where the robot has two arms, but this does not intend to suggest any limitation, and the robot may have three or more arms.

The above-described processing functions are implemented by a computer. In this case, a program in which processing details of the functions to be achieved by a processing device (CPU) are written are provided. The execution of the program by the computer allows the computer to implement the above described processing functions. The program in which the processing details are written can be stored in a storage medium (however, excluding carrier waves) readable by a computer.

When the program is distributed, it may be sold in the form of a portable storage medium such as a DVD (Digital Versatile Disc) or a CD-ROM (Compact Disc Read Only Memory) storing the program. The program may be stored in a storage device of a server computer, and the program may be transferred from the server computer to another computer over a network.

A computer executing the program stores the program stored in a portable storage medium or transferred from a server computer in its own storage device. The computer then reads the program from its own storage device, and executes a process according to the program. The computer may directly read the program from a portable storage medium, and execute a process according to the program. Alternatively, the computer may successively execute a process, every time the program is transferred from a server computer, according to the received program.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. An information processing device comprising:
a memory; and
a processor coupled to the memory and configured to:
calculate, when an assignment destination of a single task assigned to a person is changed to one of a plurality of arms of a robot in a state where tasks are assigned to the person and each arm of the robot, a working time of the person and a working time of the robot after the change of the assignment destination;
compare the calculated working time of the person with the calculated working time of the robot; and
generate a warning when the working time of the robot is longer than the working time of the person as a result of comparison.

2. The information processing device according to claim 1, wherein
the processor is configured to display the warning that is selectable whether to allow the change of the assignment destination.

3. The information processing device according to claim 1, wherein
the processor is configured to calculate the working time of the robot based on whether an operation included in each task assigned to each arm of the robot is an operation in an interference region in which the arms interfere with each other or a non-interference region in which the arms do not interfere with each other.

4. The information processing device according to claim 1, wherein
the processor is configured to calculate the working time of the robot based on whether an operation included in each task assigned to each arm of the robot is an operation which at least two of the arms cooperatively execute.

5. The information processing device according to claim 1, wherein
the processor is configured to, when receiving selection of a single non-operating time zone from non-operating time zones of each arm of the robot, identify and present a task assigned to the person, the assignment destination of the task being changeable to the selected non-operating time zone, and
the processor is configured to, when receiving selection of the presented task, calculate the working time of the robot after the selected task is assigned to the selected non-operating time zone, and calculate the working time of the person excluding a working time for the selected task.

6. A non-transitory computer readable storage medium storing a work plan editing support program causing a computer to execute a process, the process comprising:
calculating, when an assignment destination of a single task assigned to a person is changed to one of a plurality of arms of a robot in a state where tasks are assigned to the person and each arm of the robot, a working time of the person and a working time of the robot after the change of the assignment destination;
comparing the calculated working time of the person with the calculated working time of the robot; and
generating a warning when the working time of the robot is longer than the working time of the person as a result of comparison.

7. The non-transitory computer readable storage medium according to claim 6, wherein
the generating the warning includes displaying the warning that is selectable whether to allow the change of the assignment destination.

8. The non-transitory computer readable storage medium according to claim 6, wherein
the calculating includes calculating the working time of the robot based on whether an operation included in each task assigned to each arm of the robot is an operation in an interference region in which the arms interfere with each other or a non-interference region in which the arms do not interfere with each other.

9. The non-transitory computer readable storage medium according to claim 6, wherein
the calculating includes calculating the working time of the robot based on whether an operation included in each task assigned to each arm of the robot is an operation which at least two of the arms cooperatively execute.

10. The non-transitory computer readable storage medium according to claim 6, further comprising:
identifying and presenting, when receiving selection of a single non-operating time zone from non-operating time zones of each arm of the robot, a task assigned to the person, the assignment destination of the task being changeable to the selected non-operating time zone, and wherein
the calculating includes, when receiving selection of the presented task, calculating the working time of the robot after the selected task is assigned to the selected non-operating time zone, and calculating the working time of the person excluding a working time for the selected task.

11. A work plan editing support method implemented by a computer, the method comprising:
calculating, when an assignment destination of a single task assigned to a person is changed to one of a plurality of arms of a robot in a state where tasks are assigned to the person and each arm of the robot, a working time of the person and a working time of the robot after the change of the assignment destination;
comparing the calculated working time of the person with the calculated working time of the robot; and
generating a warning when the working time of the robot is longer than the working time of the person as a result of comparison.
